(19) United States
(12) Patent Application Publication
(10) Pub. No.: US 2026/0134193 A1
(43) Pub. Date: May 14, 2026

(54) Voice Dictation With Audio Large Language Model

(71) Applicant: Google LLC, Mountain View, CA (US)

(72) Inventors: Quan Wang, Hoboken, NJ (US); Francoise Beaufays, Mountain View, CA (US); Bhuvana Ramabhadran, Mt. Kisco, NY (US); Zhong Meng, Mountain View, CA (US); Neng Chen, Mountain View, CA (US); Antoine Bruguier, Milpitas, CA (US); Yanzhang He, Mountain View, CA (US); Golan Pundak, New York, NY (US); Guanlong Zhao, Union City, NJ (US)

(73) Assignee: Google LLC, Mountain View, CA (US)

(21) Appl. No.: 18/943,864

(22) Filed: Nov. 11, 2024

(51) Int. Cl. G06F 40/166; G06F 40/279

(52) U.S. Cl. CPC G06F 40/166; G06F 40/279

(57) ABSTRACT

A method includes receiving audio data characterizing an utterance spoken by a user. The method also includes processing the audio data to generate a transcription of the utterance using a multimodal large language model (LLM). The transcription includes a sequence of terms. The method also includes processing, using the multimodal LLM, the audio data and the transcription in parallel to identify one or more revision terms in the sequence of terms. The one or more revision terms specify a revision action to perform on at least on other term in the sequence of terms. The method also includes modifying the transcription based on the one or more revision terms.

### TECHNICAL FIELD

This disclosure relates to voice dictation with an audio large language model.

### BACKGROUND

Automatic speech recognition (ASR) aims to transcribe speech into text. End-to-end speech recognition models integrate several components into a single model thereby improving performance (e.g., word error rate (WER) and latency) of transcribing speech into text. Some systems incorporate several cascaded models are capable of performing ASR in multiple different languages. Recently, speech recognition models have benefited from training on both audio data and text data. Yet, the use of audio data and text data introduces certain difficulties due to the modality gap between audio and text. Many current approaches use multiple models to process audio and text which is expensive and difficult to maintain as each of these models use different data sources, training processes, and evaluation metrics.

### DESCRIPTION OF DRAWINGS

FIGS. 1A and 1B are schematic views of an example speech recognition system.

FIG. 2 is a schematic view of an example transcription with an inserted revision token.

FIG. 3 is a schematic view of an example training process for training a multimodal large language model.

FIG. 4 is a flowchart of an example arrangement of operations for a computer-implemented method of performing voice dictation with a large language model.

FIG. 5 is a schematic view of an example computing device that may be used to implement the systems and methods described herein.

Like reference symbols in the various drawings indicate like elements.

### SUMMARY

One aspect of the disclosure provides a computer-implemented method executed on data processing hardware that causes the data processing hardware to perform operations for performing voice dictation using a large language model. The operations include receiving audio data characterizing an utterance spoken by a user. The operations also include processing the audio data to generate a transcription of the utterance using a multimodal large language model (LLM). The transcription includes a sequence of terms. The operations also include processing the audio data and the transcription in parallel to identify one or more revision terms in the sequence of terms using the multimodal LLM. The one or more revision terms specify a revision action to perform on at least one other term in the sequence of terms. The operations also include modifying the transcription based on the one or more revision terms.

Implementations of the disclosure may include one or more of the following optional features. In some implementations, the operations further include determining a corresponding intent of the user when speaking the respective term based on processing the audio data and the transcription in parallel. Here, identifying the one or more revision terms in the sequence of terms is based on the corresponding intent determined for each respective term in the sequence of terms. In some examples, for each respective term in the sequence of terms, processing the audio data and the transcription in parallel includes determining corresponding speech characteristics based on processing the audio data, determining a corresponding linguistic context based on processing the transcription, and correlating the corresponding speech characteristics of the respective term with the corresponding linguistic context of the respective term. Here, the corresponding speech characteristics of the respective term may not be conveyed in the transcription and the corresponding linguistic context of the respective term is not conveyed in the audio data. In these examples, the corresponding speech characteristics may include at least one of pitch information, tone information, or prosody information.

In some implementations, the operations further include inserting a revision token into the sequence of terms based on the one or more revision terms. The revision token indicating a corresponding N number of terms in the at least one other term and corresponding replacement terms for replacement of the corresponding N number of terms in the at least one other term. In these implementations, modifying the transcription is further based on the revision token inserted into the sequence of terms. The operations may further include obtaining context data associated with the user that spoke the utterance and conditioning the multimodal LLM on the context data.

In some examples, the operations further include determining a training prompt for an auxiliary multimodal LLM, generating a plurality of training examples based on the training prompt using the auxiliary multimodal LLM, and training the multimodal LLM on the plurality of training examples. The training prompt includes a transcription editing task and a plurality of training samples. Each respective training sample includes a corresponding training transcription paired with a corresponding training modified transcription. The revision action may include at least one of a replacement action, a deletion action, or a spelling action.

Another aspect of the disclosure provides a system for operating an influencer scoring model. The system includes data processing hardware and memory hardware in communication with the data processing hardware. The memory hardware storing instructions that when executed on the data processing hardware cause the data processing hardware to perform operations. The operations include receiving audio data characterizing an utterance spoken by a user. The operations also include processing the audio data to generate a transcription of the utterance using a multimodal large language model (LLM). The transcription includes a sequence of terms. The operations also include processing the audio data and the transcription in parallel to identify one or more revision terms in the sequence of terms using the multimodal LLM. The one or more revision terms specify a revision action to perform on at least one other term in the sequence of terms. The operations also include modifying the transcription based on the one or more revision terms.

Implementations of the disclosure may include one or more of the following optional features. In some implementations, the operations further include determining a corresponding intent of the user when speaking the respective term based on processing the audio data and the transcription in parallel. Here, identifying the one or more revision terms in the sequence of terms is based on the corresponding intent determined for each respective term in the sequence of terms. In some examples, for each respective term in the sequence of terms, processing the audio data and the transcription in parallel includes determining corresponding speech characteristics based on processing the audio data, determining a corresponding linguistic context based on processing the transcription, and correlating the corresponding speech characteristics of the respective term with the corresponding linguistic context of the respective term. Here, the corresponding speech characteristics of the respective term may not be conveyed in the transcription and the corresponding linguistic context of the respective term is not conveyed in the audio data. In these examples, the corresponding speech characteristics may include at least one of pitch information, tone information, or prosody information.

In some implementations, the operations further include inserting a revision token into the sequence of terms based on the one or more revision terms. The revision token indicating a corresponding N number of terms in the at least one other term and corresponding replacement terms for replacement of the corresponding N number of terms in the at least one other term. In these implementations, modifying the transcription is further based on the revision token inserted into the sequence of terms. The operations may further include obtaining context data associated with the user that spoke the utterance and conditioning the multimodal LLM on the context data.

In some examples, the operations further include determining a training prompt for an auxiliary multimodal LLM, generating a plurality of training examples based on the training prompt using the auxiliary multimodal LLM, and training the multimodal LLM on the plurality of training examples. The training prompt includes a transcription editing task and a plurality of training samples. Each respective training sample includes a corresponding training transcription paired with a corresponding training modified transcription. The revision action may include at least one of a replacement action, a deletion action, or a spelling action.

The details of one or more implementations of the disclosure are set forth in the accompanying drawings and the description below. Other aspects, features, and advantages will be apparent from the description and drawings, and from the claims.

### DETAILED DESCRIPTION

Automatic speech recognition (ASR) is the process of converting spoken utterances into text. As such, automatic speech recognition may be used to recognize spoken commands that are performed by a digital assistant or recognize spoken queries that are answered by the digital assistant. Moreover, automatic speech recognition may be used for dictation. For example, a user may speak a long-form utterance (e.g., minutes or hours of continuous speech) that is transcribed by the ASR model. However, when users speak such long-form utterances, users will oftentimes wish to correct one or more terms they previously spoke. For instance, a user may speak a sequence of terms corresponding to a list of items and subsequently want to reorder one or more items in the list, add or remove one more items from the list, specify a particular text formatting (e.g., punctuation, capitilizaion, a list of items and subsequently want to reorder one or more items in the list, add or remove

Implementations herein are directed to methods and systems of performing voice dictation with a large language model. In particular, the method includes receiving audio data characterizing an utterance spoken by a user. The method also includes processing the audio data to generate a transcription of the utterance using a multimodal large language model (LLM). The transcription includes a sequence of terms. The method also includes processing the audio data and the transcription in parallel to identify one or more revision terms in the sequence of terms using the multimodal LLM. The one or more revision terms specify a revision action to perform on at least one other term in the sequence of terms. The method also includes modifying the transcription based on the one or more revision terms. As will become apparent, the multimodal LLM advantageously leverages processing the audio data and text data (i.e., transcription) in parallel as compared to using different audio models and text models to process audio and text, respectively.

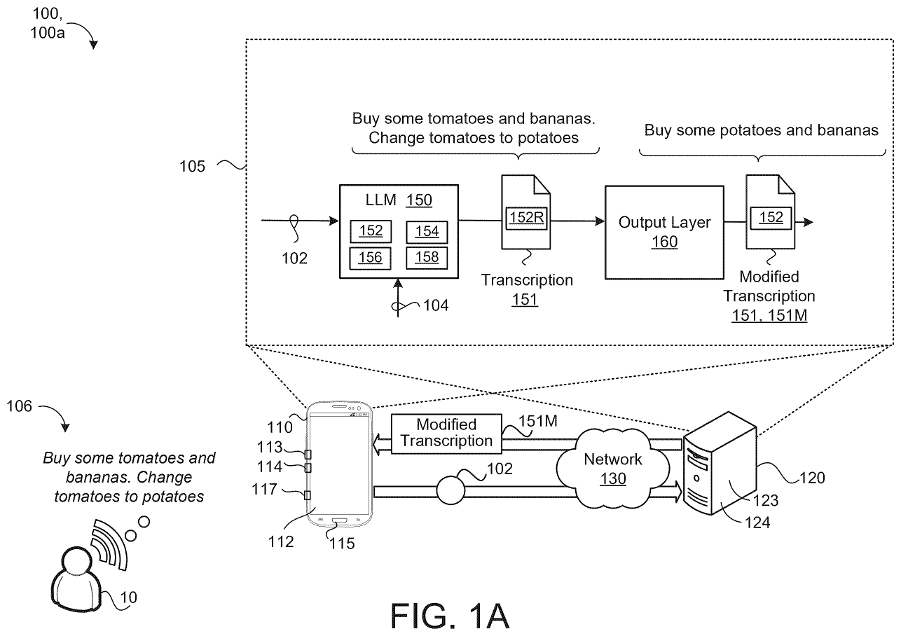

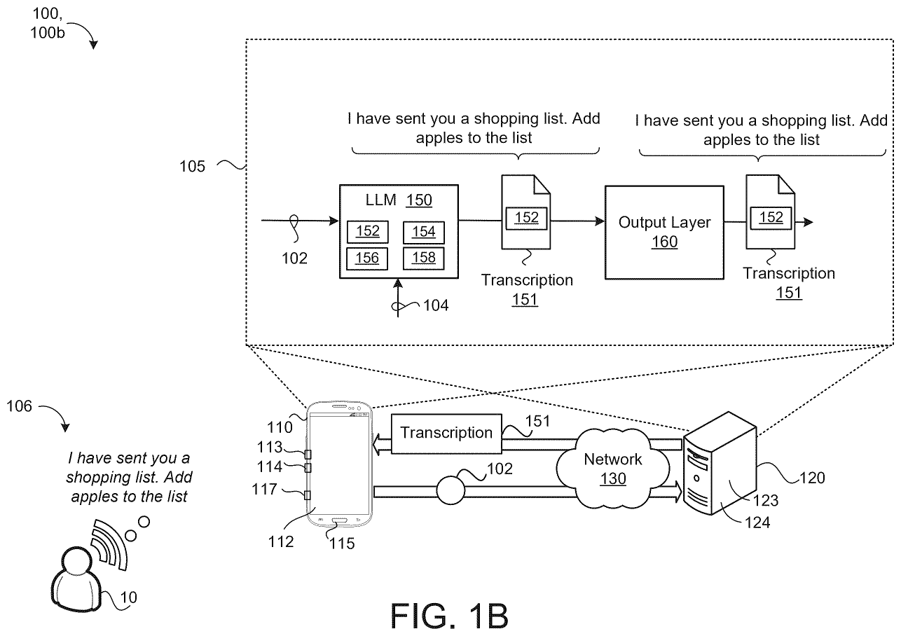

FIGS. 1A and 1B show an example system 100 including a speech recognition system 105. Generally, the user 10 speaks, via a user device 110, an utterance 106 directed towards a multimodal LLM 150. The speech recognition system 105 includes the user device 110, a remote computing system 120, and a network 130. The user device 110 includes data processing hardware 113 and memory hardware 114. The user device 110 may include, or be in communication with, an audio capture device 115 (e.g., an array of one or more microphones) for converting utterances 106 or natural language queries spoken by the user 10 into corresponding audio data (e.g., sequence of acoustic frames) 102. In addition to, or in lieu of, spoken input, the user 10 may input a textual representation of the natural language query via a user interface executing on the user device 110.

The user device 110 may be any computing device capable of communicating with the remote computing system 120 through the network 130. The user device 110 includes, but is not limited to, desktop computing devices and mobile computing devices, such as laptops, tablets, smart phones, smart speakers/displays, digital assistant devices, smart appliances, internet-of-things (IoT) devices, infotainment systems, vehicle infotainment systems, and wearable computing devices (e.g., headsets, smart glasses, and/or watches). The remote computing system 120 may be a distributed system (e.g., cloud computing environment) having scalable elastic resources. The resources include computing resources 123 (e.g., data processing hardware) and/or storage resources 124 (e.g., memory hardware). Additionally or alternatively, the remote computing system 120 may be a centralized system. The network 130 may be wired, wireless, or a combination thereof, and may include private networks and/or public networks, such as the Internet.

The multimodal LLM 150 is configured to process the audio data 102 to generate a transcription 151 of the utterance 106 spoken by the user 10. Alternatively, a separate ASR model may process the audio data 102 to generate the transcription 151, whereby the multimodal LLM 150 subsequently processes the audio data 102 and the transcription 151 output by the ASR model in parallel to identify one or more revision terms 152, 152R in the sequence of terms 152. The transcription 151 includes a sequence of terms 152 each representing a respective word or term in the utterance 106 spoken by the user 10. In some scenarios, the user 10 may want to edit or revise one or more words in the utterance 106 previously spoken by the user 10. Simply put, the user may want to revise (e.g., edit, delete, etc.) words that the user previously spoke such that the output from the multimodal LLM 150 reflects the revision. To that end, the multimodal LLM 150 is configured to process the audio data 102 and the transcription 151 in parallel to identify one or more revision terms 152, 152R in the sequence of terms 152. The one or more revision terms 152R may specify a revision action to perform on at least one other term 152 in the sequence of terms 152. The revision action may include any action that edits or modifies the transcription 151 or the at least one other term 152 in any manner. For instance, the revision action may include adding one or more terms 152 in between terms already spoken by the user 10, deleting a term spoken by the user, and/or reordering one or more terms already spoken by the user. In some examples, the revision action may include a text formatting action, such as correcting a speech disfluency, adding punctuation to the text, summarizing the text, etc. The revision action may include at least one of a replacement action, a deletion action, or a spelling (e.g., re-spelling) action.

Notably, some utterances 160 include revision terms 152R while other utterances 106 do not include revision terms 152R. As such, the multimodal LLM 150 may determine whether the spoken utterance 106 includes such revision terms 152R. The revision terms 152R are not predefined terms that cause the revision action. For example, speaking the term “change” in one context may mean changing the transcription 151 while speaking the same term “change” in another context may be a word the user 10 wishes to be transcribed. Thus, the multimodal LLM 150 determines whether revision terms 152R are present within each transcription 151 by determining the context of each term 152 within the transcription 151.

The user 10 may realize that one or more words previously spoken needs to be modified or revised in some manner. As such, the user 10 may subsequently speak one or more other words describing and/or explaining the revision to perform on the transcription 151. For example, the user 10 may speak the utterance 106 of “I will go home at 4 pm. Sorry, not 4 pm, I mean 5 pm.” for which the multimodal LLM 150 generates the transcription 151 corresponding to the utterance 106. In this example, “4 pm” represents the term 152 the user 10 wishes to change or modify such that the user 10 speaks the revision terms 152R of “Sorry, not 4 pm, I mean 5 pm.” Here, the revision terms 152R specify the revision action of replacing the term 152 “4 pm” with “5 pm.” Notably, in this example, the revision terms 152R do not explicitly state the revision action (e.g., “replacing”) to be performed. As such, the multimodal LLM 150 may infer the revision action from the transcription 151 based on the context of the revision terms 152R within the transcription 151 by performing semantic interpretation on the transcription 151. On the other, hand the revision terms 152R may explicitly state the revision action to be performed. For example, the user 10 may explicitly state their intent to replace a certain term with another term.

Not all utterances 106 spoken by the user 10 include revision terms 152R. In some implementations, for each respective term 152 in the sequence of terms 152, the multimodal LLM 150 determines a corresponding intent 154 of the user 10 when speaking the respective term 152 based on processing the audio data 102 and the transcription 151 in parallel. The intent 154 indicates whether the user 10 intended, at the time of speaking the term 152, to transcribe the term 152 or to specify a revision action to revise another one of the terms 152. Thus, the multimodal LLM 150 identifies the one or more revision terms 152R based on the corresponding intent 154 determined for each respective term 152 in the sequence of terms 152. Continuing with the example above, even though the user 10 spoke the term “4 pm” in error, the multimodal LLM 150 would determine that the user 10 intended to transcribe the term “4 pm” at the time of speaking the term. That is, in this example, the user 10 did not realize speaking “4 pm” was an error until after the user 10 spoke the term. Thus, a user 10 may initially intend to transcribe a certain term and then subsequently decide that term 152 needs to be revised in some manner. Moreover, in some examples, the user 10 does not explicitly state any revision action but intends certain actions to be performed upon the transcription 151. For instance, the user 10 may speak an utterance 106 and wish for the transcription to include punctuation, particular text formatting, a summarization of the utterance 160, etc. without speaking such revision action. For example, the user 10 may pause after speaking a term 152 and wish to transcribe a comma after that term without explicitly stating such action or wish to add an exclamation point after a term.

FIG. 1A illustrates a first example system 100, 100a whereby the user 10 speaks the utterance 106 of “Buy some tomatoes and bananas. Change tomatoes to potatoes.” and the user device 110 converts the utterance 106 into corresponding audio data 102. Here, the multimodal LLM 150 processes the audio data 102 to generate the transcription 151 of “Buy some tomatoes and bananas. Change tomatoes to potatoes.” Notably, in this example, the user 10 does not intend for the multimodal LLM 150 to output a final transcription that includes tomatoes. As such, the multimodal LLM 150 processes the transcription 151 and the audio data 102 in parallel to identify the one or more revision terms 152R. Continuing with the example shown, the multimodal LLM 150 identifies the revision terms 152R of “Change tomatoes to potatoes” that specify the revision action of replacing or changing tomatoes with potatoes.

In some examples, the assistant LLM 150 processes the audio data 102 and the transcription 151 in parallel by, for each respective term 152 in the sequence of terms 152, determining corresponding speech characteristics 156 of the respective term 122, determining a corresponding linguistic context 158 of the respective term 122, and correlating the corresponding speech characteristics 156 of the respective term 122 with the corresponding linguistic context 158 of the respective term 122. The parallel processing of the audio data 102 and the transcription 151 contrasts with sequential processing which first processes the audio data 102 to generate the transcription 151 and determine speech characteristics 156 and then processes the transcription 151 to determine linguistic context 158. Simply put, sequential processing initially processes the audio data 102 and then processes the transcription 151 thereafter without ever correlating the speech characteristics 156 (e.g., determined from processing the audio data 102) and the linguistic context 158 (e.g., determined from processing the transcription 151).

Advantageously, the parallel processing enables such correlation between the linguistic context 158 and the speech characteristics 156 to thereby better inform the multimodal LLM 150 the intent of the user 10 when speaking each term that would otherwise not be apparent from the audio data 102 or the transcription 151 alone. The corresponding speech characteristics 156 of the respective term 152 are not conveyed in the transcription 151 and the corresponding linguistic context 158 of the respective term is not conveyed in the audio data 102. As such, correlating the linguistic context 158 and the speech characteristics 158 together (e.g., by parallel processing of the transcription 151 and the audio data 102) enables the multimodal LLM 150 to correlate the speech characteristics 156 of each term with the corresponding linguistic context 158 of the same term. For example, speaking a term 152 with a rising or lowering pitch when paired with the linguistic context of the term 152 within the transcription 151 may inform the multimodal LLM 150 that the term 152 should be transcribed with punctuation (e.g., comma, exclamation point, etc.). In this example, the linguistic context 158 of the term alone may be insufficient to inform the multimodal LLM 150 of the intent of the user 10 (e.g., intent of punctuation versus no punctuation) while the correlation of the speech characteristics 156 (e.g., rising pitch in the voice of the user 10 while speaking the term) with the linguistic context 158 sufficiently informs the multimodal LLM 150 that the term should be transcribed with punctuation.

The speech characteristics 156 generally represent how the utterance 106 was spoken. For instance, the speech characteristics 156 may include at least one of pitch information, tone information, and/or prosody information of each term 152 of the transcription 151. On the other hand, the linguistic context 158 provides semantic meaning for each term 152 within the transcriptions 151. Put another way, the linguistic context 158 provides semantic meaning for each term 152 in the transcription 151 with respect to one or more other terms 152 in the transcription 151. In some scenarios, processing either the speech characteristics 156 or the linguistic context 158 alone is insufficient to identify the revision terms 152R. For instance, when the utterance 106 includes certain speech disfluencies, such as long pauses, repeated words, or stuttering, the linguistic context 158 of the transcription 151 alone may not be enough to discern whether some terms 152 were intended for the transcription 151 or not. Yet, processing the speech characteristics 156 and the linguistic context 158 in parallel may provide such insights. For example, repeated words in the transcription 151 paired with a lower pitch may inform the multimodal LLM 150 that the repeated words were not intended for the transcription. In another example, speaking a term with a rising pitch may inform the multimodal LLM 150 that an exclamation point should be added after such term.

FIG. 1B illustrates a second system 100, 100b whereby the user 10 speaks the utterance 106 of “I have sent you a shopping list. Add apples to the list.” Here, the multimodal LLM 150 processes the audio data 102 to generate the transcription 151 of “I have sent you a shopping list. Add apples to the list.” Notably, in this example, the user 10 intends the entire utterance 106 to be transcribed as none of the terms 152 correspond to revision terms 152R. As such, the multimodal LLM 150 processes the transcription 151 and the audio data 102 in parallel to identify whether any revision terms 152R exist within the transcription 151. In the example shown, the multimodal LLM 150 does not identify any revision terms 152R such that the output layer 160 outputs the same transcription 151 generated by the multimodal LLM 150. In this particular example, the multimodal LLM 150 determined that the term “add” is not a revision term 152R within the context of this particular utterance 106. That is, rather than simply assuming that the term “add” maps to a certain action and performing such action on the transcription 151, the multimodal LLM 150 processes the audio data 102 and the transcription 151 in parallel to determine that the term “add” in this scenario is intended to be transcribed rather than specify a revision action.

Referring again to FIGS. 1A and 1B, in some implementations, the multimodal LLM 150 obtains context data 104 associated with the user 10 that spoke the utterance 106 whereby the multimodal LLM 150 is conditioned on the context data 104. The context data 104 may indicate at least one of a user profile (e.g., contact names), device information (e.g., location, text displayed on the screen, etc.), previously spoken utterance 106, and/or operating system information (e.g., date, time, etc.). Thus, by conditioning the multimodal LLM 150 on the context data 104, the conditioned multimodal LLM 150 may generate transcriptions 151 tailored more specifically to the particular user 10. For instance, the multimodal LLM 150 may obtain context data 104 indicating contact names of a user 106 that spoke the utterance 106 of “Call Christyne.” Thus, the multimodal LLM 150 may initially generate the transcription 151 of “Call Christine” and then generate the modified transcription 151, 151M of “Call Christyne” based on the context data 104.

In some implementations, the multimodal LLM 150 operates in a streaming manner such that each term 152 from the transcription 151 is displayed on a screen of the user device 110 as soon as it is recognized. As such, the user 10 may see the transcription 151 of each term 151 in real-time as they are speaking the utterance 106. Moreover, this enables the user 10 to discern whether any of the previous terms spoken by them were misrecognized as they are speaking the utterance 106. For instance, the user 10 may speak the utterance 106 of “remind me to call Christyne change Christine to C H R I S T Y N E.” Here, the multimodal LLM 150 may generate and display the transcription 151 of “remind me to call Christine” before the user 10 speaks the term “tomorrow.” As such, the user 10 may observe the misspelling of “Christyne” and instruct the multimodal LLM 150 to correct the spelling by speaking “change Christine to C H R I S T Y N E” whereby the multimodal LLM 150 identifies the revision terms 152R of “change Christine to C H R I S T Y N E” and modifies the transcription 151 to the modified transcription 151M of “remind me to call Christyne” before the user 10 speaks the term “tomorrow.”

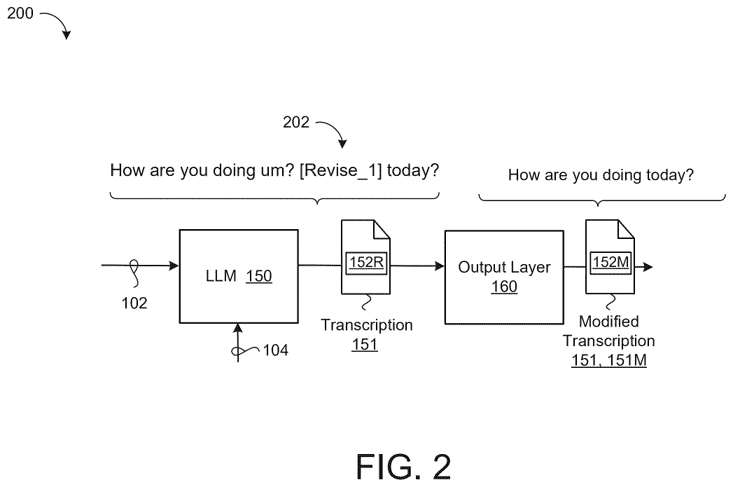

FIG. 2 shows a schematic view 200 of the multimodal LLM 150 inserting one or more revision tokens 202 into the sequence of terms 152 of the transcription 151 based on the one or more revision terms 152R. Each revision token 202 indicates a corresponding N number of terms 152 in the at least one other term 152 and corresponding replacement terms (if any) for replacement of the corresponding N number of terms 152 in the at least one other term. Thus, the revision token 202 indicates to the output layer 160 which terms 152 need to be modified or revised and may further indicate the replacement terms used to replace such terms 152. For instance, in the example shown in FIG. 2, the multimodal LLM 150 receives audio data 102 for an utterance corresponding to “how are you doing um? change um to today?” Thus, the multimodal LLM 150 may process the audio data 102 to generate a transcription 151 that includes a sequence of terms 152 and a revision token 202. In the example shown, the transcription 151 includes “how are you doing um? [Revise_1] today?” In this example, “[Revise_1]” indicates the revision token 202 whereby the revision action indicates deleting the term “um?” More specifically, “1” from the revision token 202 indicates 1 number of terms for revision and since the revision action is deletion, there are no replacement terms. Put another way, the revision token 202 in this example indicates that the one prior term 152 of “um?” is intended to be deleted. In other examples, the revision token 202 may further indicate one or more replacement terms to replace the term “um?” rather than simply deleting the term. Consequently, the output layer 160 may process the transcription 151 that includes the revision token 202 and the replacement terms (if any) to generate the modified transcription 151M. In the example shown, the output layer 160 would generate the modified transcription 151M of “how are you doing today?” The modified transcription 151M includes a sequence of modified terms 152, 152M. That is, the modified terms 152M include the same terms from the sequence of terms 152 with modified terms 152M specified by the revision action.

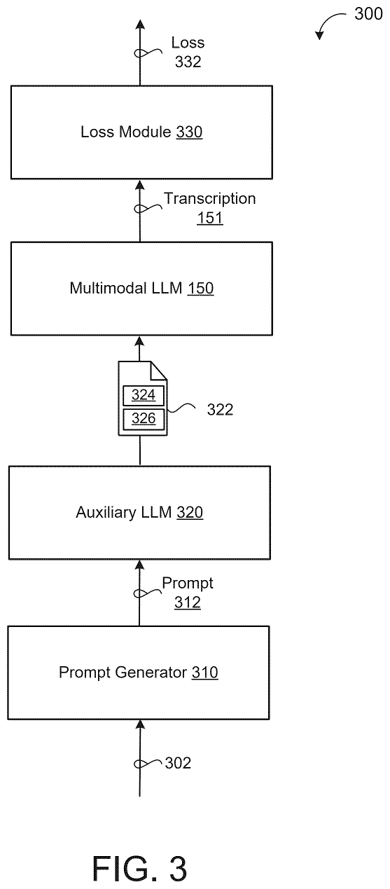

FIG. 3 illustrates an example training process 300 for training the multimodal LLM 150. The training process 300 includes a prompt generator 310, an auxiliary multimodal LLM 320, and a loss module 330. The prompt generator 310 receives a request 302 and determines a training prompt 312 for the auxiliary multimodal LLM 320. The training prompt 312 includes a transcription editing task and a plurality of training samples. For example, the transcription editing task may request the auxiliary multimodal LLM 320 to generate training examples that include one or more of speech disfluency examples, speech addition examples, speech deletion examples, and/or misspelling examples. For instance, the speech deletion examples may include speech that the user 10 spoke and then the user 10 decided to delete one or more of the previous terms. Each respective training sample includes a corresponding training transcription paired with a corresponding modified transcription. In some examples, the training prompt 312 includes “generate paired speech and text examples that corresponds to a user wanting to delete a previous term they have spoken from a transcription. Here are a few examples for reference [sample_1], [sample_2], and [sample_3]. The auxiliary multimodal LLM 320 is different from the multimodal LLM 150 and generates a plurality of training examples 322 based on the training prompt 312. Each training example 322 includes a training transcription 324 paired with a corresponding training synthesized audio 326. Thereafter, the auxiliary LLM 150 receives each training example 322 and generates a corresponding transcription 151 based on the training example 322. More specifically, the auxiliary LLM 150 generates the corresponding transcription 151 based on processing the training synthesized audio 326. In some examples, the auxiliary LLM 150 generates the transcription 151 based on each training example 322. In other examples, the auxiliary LLM 150 generates the modified transcription 151M based on each training example 322.

The loss module 330 receives each transcription 151 generated by the auxiliary LLM 150 and determines a corresponding loss 332 based on the transcription 151 and the training transcription 324. That is, the loss module 330 compares the transcription 151 generated by the auxiliary LLM 320 with the corresponding training transcription 324 to determine the loss 332 for each training example 322. The training process 300 trains the multimodal LLM 150 based on each corresponding loss 332 determined for each training example 322. Advantageously, the training process 300 may leverage the multimodal capability of the auxiliary LLM 320 to generate diverse training examples 322 which are used to train the multimodal LLM 150.

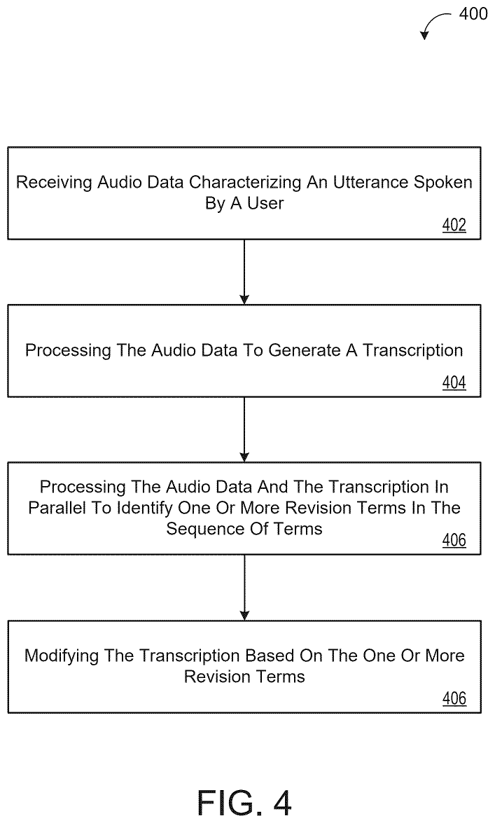

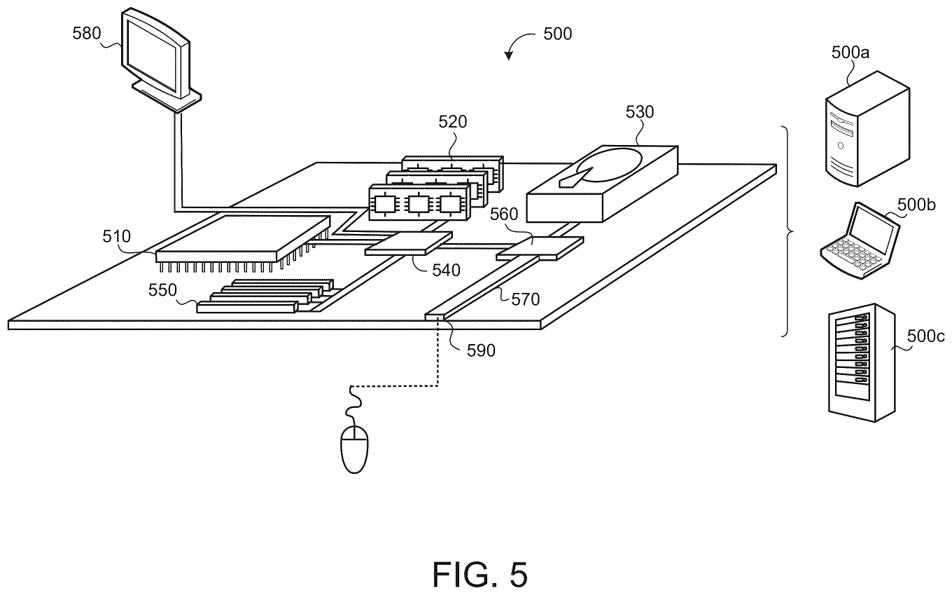

FIG. 4 is flowchart of an example arrangement of operations for a computer-implemented method 400 for performing voice dictation using a large language model. The method 400 may execute on data processing hardware 510 (FIG. 5) based on instructions stored on memory hardware 520 (FIG. 5). In some examples, the data processing hardware 510 includes data processing hardware 113 of the user device 110 and the memory hardware 520 includes the memory hardware 114 of the user device 110 In other examples, the data processing hardware 510 includes the data processing hardware 123 of the remote computing system 120 and the memory hardware 420 includes the memory hardware 124 of the remote computing system 120.

At operation 402, the method 400 includes receiving audio data 102 characterizing an utterance 106 spoken by a user 10. At operation 404, the method 400 includes processing the audio data 102 to generate a transcription 151 of the utterance 106 using a multimodal large language model (LLM) 150. The transcription 151 includes a sequence of terms 152. At operation 406, the method 400 includes processing, using the multimodal LLM 150, the audio data 102 and the transcription 151 in parallel to identify one or more revision terms 152R in the sequence of terms 151. The one or more revision terms 152R specify a revision action to perform on at least one other term 152 in the sequence of terms 152. At operation 308, the method 300 includes modifying the transcription 151 based on the one or more revision terms 152R.

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving audio data characterizing an utterance spoken by a user;
processing the audio data to generate a transcription of the utterance, the transcription comprising a sequence of terms;
processing, using a multimodal large language model (LLM), the audio data and the transcription in parallel to identify one or more revision terms in the sequence of terms, the one or more revision terms specifying a revision action to perform on at least one other term in the sequence of terms; and
modifying the transcription based on the one or more revision terms.

2. The computer-implemented method of claim 1, wherein the operations further comprise:
for each respective term in the sequence of terms, determining a corresponding intent of the user when speaking the respective term based on processing the audio data and the transcription in parallel,
wherein identifying the one or more revision terms in the sequence of terms is based on the corresponding intent determined for each respective term in the sequence of terms.

3. The computer-implemented method of claim 1, wherein processing the audio data and the transcription in parallel comprises, for each respective term in the sequence of terms:
based on processing the audio data, determining corresponding speech characteristics of the respective term;
based on processing the transcription, determining a corresponding linguistic context of the respective term; and
correlating the corresponding speech characteristics of the respective term with the corresponding linguistic context of the respective term.

4. The computer-implemented method of claim 3, wherein:
the corresponding speech characteristics of the respective term are not conveyed in the transcription; and
the corresponding linguistic context of the respective term is not conveyed in the audio data.

5. The computer-implemented method of claim 3, wherein the corresponding speech characteristics comprise at least one of:
pitch information;
tone information; or
prosody information.

6. The computer-implemented method of claim 1, wherein the operations further comprise, based on the one or more revision terms, inserting a revision token into the sequence of terms, the revision token indicating a corresponding N number of terms in the at least one other term and corresponding replacement terms for replacement of the corresponding N number of terms in the at least one other term.

7. The computer-implemented method of claim 6, wherein modifying the transcription is further based on the revision token inserted into the sequence of terms.

8. The computer-implemented method of claim 1, wherein the operations further comprise:
obtaining context data associated with the user that spoke the utterance; and
conditioning the multimodal LLM on the context data.

9. The computer-implemented method of claim 1, wherein the operations further comprise:
determining a training prompt for an auxiliary multimodal LLM, the training prompt comprising a transcription editing task and a plurality of training samples, each respective training sample comprising a corresponding training transcription paired with a corresponding training modified transcription; and
generating, using the auxiliary multimodal LLM, a plurality of training examples based on the training prompt; and
training the multimodal LLM on the plurality of training examples.

10. The computer-implemented method of claim 1, wherein the revision action comprises at least one of:
a replacement action;
a deletion action; or
a spelling action.

11. A system comprising:
data processing hardware; and
memory hardware in communication with the data processing hardware, the memory hardware storing instructions that when executed on the data processing hardware cause the data processing hardware to perform operations comprising:
receiving audio data characterizing an utterance spoken by a user;
processing the audio data to generate a transcription of the utterance, the transcription comprising a sequence of terms;
processing, using a multimodal large language model (LLM), the audio data and the transcription in parallel to identify one or more revision terms in the sequence of terms, the one or more revision terms specifying a revision action to perform on at least one other term in the sequence of terms, and
modifying the transcription based on the identified one or more revision terms.

12. The system of claim 11, wherein the operations further comprise:
for each respective term in the sequence of terms, determining a corresponding intent of the user when speaking the respective term based on processing the audio data and the transcription in parallel,
wherein identifying the one or more revision terms in the sequence of terms is based on the corresponding intent determined for each respective term in the sequence of terms.

13. The system of claim 11, wherein processing the audio data and the transcription in parallel comprises, for each respective term in the sequence of terms:
based on processing the audio data, determining corresponding speech characteristics of the respective term,
based on processing the transcription, determining a corresponding linguistic context of the respective term; and
correlating the corresponding speech characteristics of the respective term with the corresponding linguistic context of the respective term.

14. The system of claim 13, wherein:
the corresponding speech characteristics of the respective term are not conveyed in the transcription, and
the corresponding linguistic context of the respective term is not conveyed in the audio data.

15. The system of claim 13, wherein the corresponding speech characteristics comprise at least one of:
pitch information;
tone information, or
prosody information.

16. The system of claim 11, wherein the operations further comprise, based on the one or more revision terms, inserting a revision token into the sequence of terms, the revision token indicating a corresponding N number of terms in the at least one other term and corresponding replacement terms for replacement of the corresponding N number of terms in the at least one other term.

17. The system of claim 16, wherein modifying the transcription is further based on the revision token inserted into the sequence of terms.

18. The system of claim 11, wherein the operations further comprise:
obtaining context data associated with the user that spoke the utterance; and
conditioning the multimodal LLM on the context data.

19. The system of claim 11, wherein the operations further comprise:
determining a training prompt for an auxiliary multimodal LLM, the training prompt comprising a transcription editing task and a plurality of training samples, each respective training sample comprising a corresponding training transcription paired with a corresponding training modified transcription; and
generating, using the auxiliary multimodal LLM, a plurality of training examples based on the training prompt; and
training the multimodal LLM on the plurality of training examples.

20. The system of claim 11, wherein the revision action comprises at least one of:
a replacement action;
a deletion action, or
a spelling action.
